(19) United States
(12) Patent Application Publication
(10) Pub. No.: US 2002/0129160 A1
(43) Pub. Date: Sep. 12, 2002

(54) Network with an adaptation of the frame structure of subnetworks

(76) Inventor: Joerg Habetha, Aachen, DE (US)

Correspondence Address: Philips Electronics North America Corporation, 580 White Plains Road, Tarrytown, NY, 10591, US

(21) Appl. No.: 10/075,310

(22) Filed: Feb. 14, 2002

(30) Foreign Application Priority Data
Feb. 19, 2001 (DE) 10107991.5

(51) Int. Cl. G06F 15/16

(52) U.S. Cl. 709/236; 709/249

(57) ABSTRACT

The invention relates to a network having a plurality of subnetworks which can each be connected each via bridge terminals and each include a controller for controlling a subnetwork. A controller is provided for shifting the frame structure of its subnetwork relative to at least a frame structure of another subnetwork.

The invention relates to a network comprising a plurality of subnetworks which can each be connected via bridge terminals and each include a controller for controlling a subnetwork. Such networks are self-organizing and can consist, for example, of a plurality of subnetworks. They are also designated as ad hoc networks.

An ad hoc network having a plurality of terminals is known from the document “J. Habetha, A. Hettich, J. Peetz, Y. Du: Central Controller Handover Procedure for ETSI-BRAN HIPERLAN/2 Ad Hoc Networks and Clustering with Quality of Service Guarantees, 1^{st} IEEE Annual Workshop on Mobile Ad Hoc Networking & Computing, Aug. 11, 2000”. At least one terminal is provided as a controller for controlling the ad hoc network. It may be necessary under specific conditions for another terminal to become controller. Division into subnetworks is necessary should such a network reach a specific size. Terminals arranged as bridge terminals serve the purpose of communication with the subnetworks. These bridge terminals are alternately synchronized with the subnetworks. Different MAC frame structures of the connected networks cause to waiting times to occur until a bridge terminal can exchange data with the newly synchronized network.

It is an object of the invention to create a network which reduces the waiting times after a bridge terminal is switched over from one subnetwork to the other.

The object is achieved by a network of the type mentioned in the opening paragraph with the aid of the following measures:

The network includes a plurality of subnetworks which can each be connected via bridge terminals and each include a controller for controlling a subnetwork which controller is provided for moving the frame structure of its subnetwork to at least a frame structure of another subnetwork.

According to the invention, the frame structure of at least one subnetwork is moved to at least a frame structure of another subnetwork, as a result of which minimization or, if appropriate, also elimination of the waiting time is achieved. The move may be carried out only up to a predefined frame difference of the frame structures of the connected subnetworks. In the ideal case, only one frame difference remains between the frame structures of the connected subnetworks, this frame difference being necessary because each bridge terminal requires a switchover time for synchronization with a subnetwork.

There are several variants for realizing move displacement. These variants are described in claims 2 to 4. A controller of a subnetwork agrees on the type of move with another controller of another subnetwork. This decision can also be carried out by a bridge terminal.

The invention also relates to a controller of a subnetwork which can be connected via bridge terminals to other subnetworks of a network.

Examples of embodiment of the invention are explained below in more detail with the aid of the figures, in which:

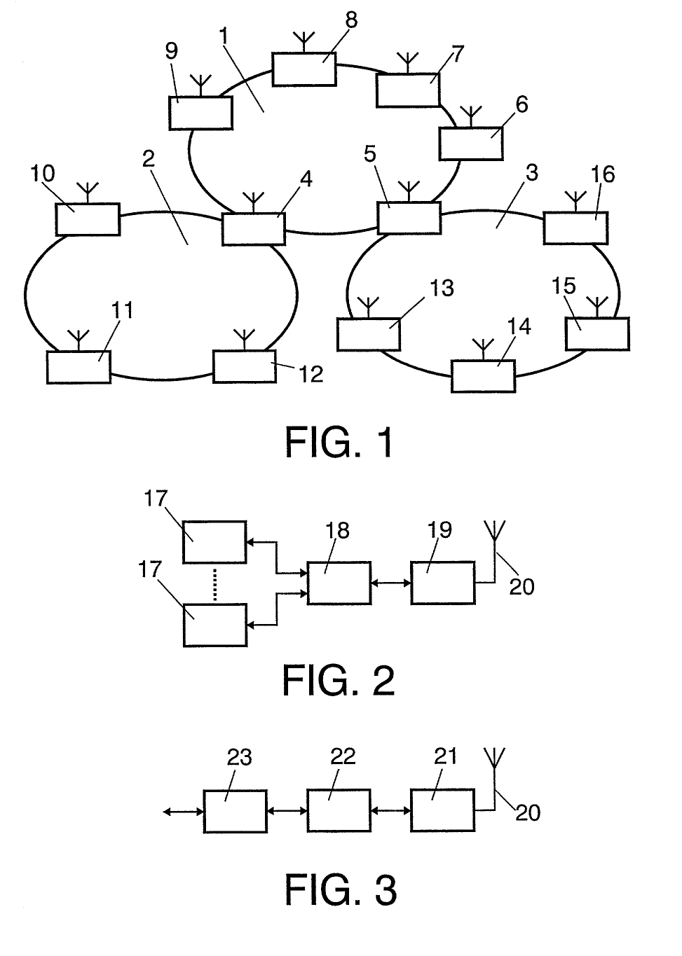

FIG. 1 shows an ad hoc network comprising three subnetworks which each include terminals provided for radio transmission,

FIG. 2 shows a terminal of the local network area as shown in FIG. 1,

FIG. 3 shows a radio device of the terminal as shown in FIG. 2,

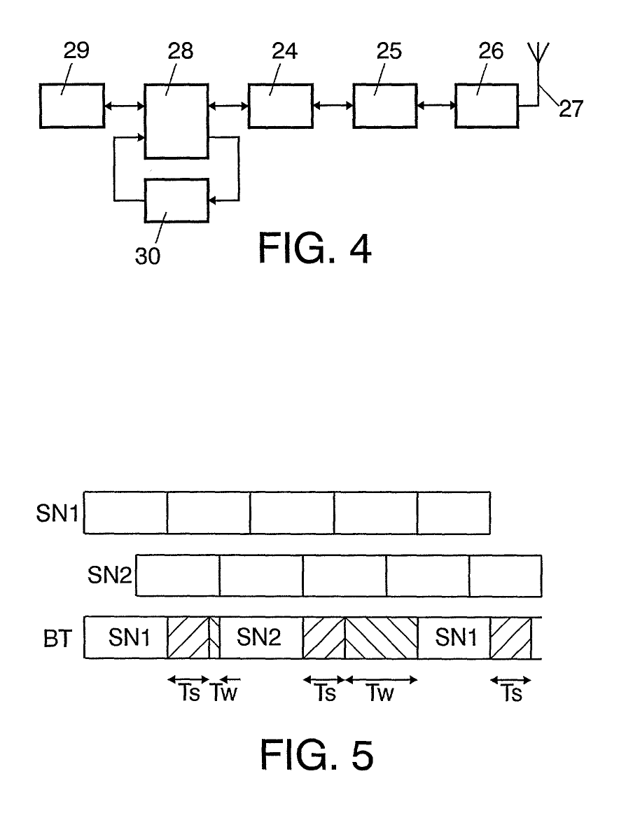

FIG. 4 shows a design of a bridge terminal provided for connecting two subnetworks,

FIG. 5 shows MAC frames of two subnetworks, and the MAC frame structure of a bridge terminal,

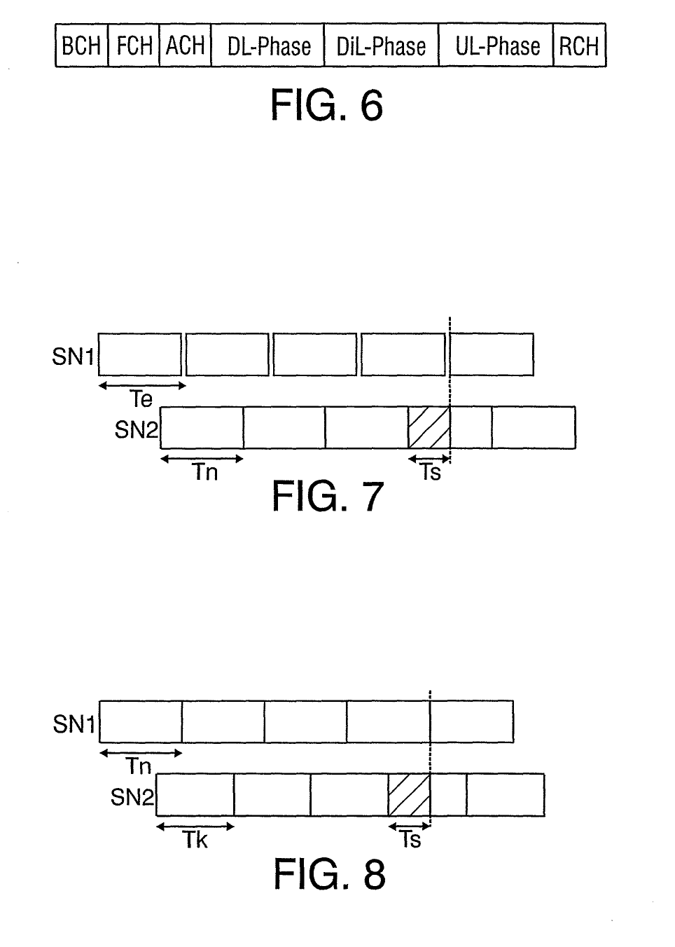

FIG. 6 shows the structure of a MAC frame, and FIGS. 7 to 10 show various frame structures of two subnetworks.

The examples of embodiment represented below relates to ad hoc networks which, by contrast with traditional networks, are self-organizing. Each terminal in such an ad hoc network can enable access to a fixed network and can be used immediately. It is characteristic of an ad hoc network that the structure and the number of subscribers are not fixed within prescribed limiting values. For example, a communication device of a subscriber can be taken out of the network or integrated. By contrast with the traditional mobile radio networks, an ad hoc network is not dependent on a permanently installed infrastructure.

The size of the area of the ad hoc network is very much larger, as a rule, than the transmission range of a terminal. A communication between two terminals can therefore necessitate the switching on of further terminals, so that these messages or data can be transmitted between the two communicating terminals. Such ad hoc networks, in the case of which messages and data must be relayed via a terminal, are designated as multihop ad hoc networks. One possible organization of an ad hoc network consists of regularly forming subnetworks or clusters. A subnetwork of the ad hoc network can, for example, be formed by subscribers seated around a table by means of terminals connected via radio links. Such terminals can be, for example, communication devices for the wireless exchange of documents, images etc.

Two types of ad hoc networks can be specified. These are decentralized and centralized ad hoc networks. In a decentralized ad hoc network, the communication between the terminals is decentralized, that is to say each terminal can communicate directly with each other terminal provided that the terminals are respectively located within the transmission range of the other terminal. The advantage of a decentralized ad hoc network is its simplicity and robustness in relation to faults. In a centralized ad hoc network, specific functions such as, for example, the function of multiple access of a terminal to the radio transmission medium (Medium Access Control=MAC), are controlled by one specific terminal per subnetwork. This terminal is designated as a central terminal or central controller (CC). These functions need not always be executed by the same terminal, but can be handed over from a terminal operating as a central controller to another terminal, then acting as a central controller. The advantage of a central ad hoc network is that it is possible therein to agree in a simple way on the quality of service (QoS). An example of a centralized ad hoc network is a network which is organized using the HIPERLAN/2 Home Environment Extension (HEE) (compare J. Habetha, A. Hettich, J. Peetz, Y. Du, “Central Controller Handover Procedure for ETSI-BRAN HIPERLAN/2 Ad Hoc Networks and Clustering with Quality of Service Guarantees”, 1^{st} IEEE Annual Workshop on Mobile Ad Hoc Networking & Computing, Aug. 11, 2000).

An example of embodiment of an ad hoc network having three subnetworks 1 to 3 which each include a plurality of terminals 4 to 16 is illustrated in FIG. 1. The constituents of the subnetwork 1 are the terminals 4 to 9, of the subnetwork 2 the terminals 4 and 10 to 12 and of the subnetwork 3 the terminals 5 and 13 to 16. In a subnetwork, the terminals belonging to a subnetwork exchange data via radio links. The ellipses marked in FIG. 1 specify the radio area of a subnetwork (1 to 3) in which radio transmission is possible largely without a problem between the terminals belonging to the subnetwork.

Terminals 4 and 5 are termed bridge terminals, because these ones enable data exchange between two subnetworks 1 and 2 or 1 and 3. The bridge terminal 4 is responsible for the data traffic between the subnetworks 1 and 2, and the bridge terminal 5 is responsible for the data traffic between the subnetworks 1 and 3.

A terminal 4 to 16 of the local network according to FIG. 1 can be a mobile or fixed communication device and includes, for example, at least a station 17, a connection control device 18 and a radio device 19 with an antenna 20, as is shown in FIG. 2. A station 17 may be, for example, a portable computer, telephone etc.

As FIG. 3 shows, a radio device 19 of the terminals 6 to 16 includes apart from the antenna 20 a high-frequency circuit 21, a modem 22 and a protocol device 23. The protocol device 23 forms packet units from the data stream received from the connection control device 18. A packet unit includes parts of the data stream and additional control information formed by the protocol device 23. The protocol device uses protocols for the LLC (LLC=Logic Link Control) layer and the MAC (MAC=Medium Access Control) layer. The MAC layer controls the multiple access of a terminal to the radio transmission medium, and the LLC layer carries out flow and error control.

As mentioned above, in a subnetwork 1 to 3 of a centralized ad hoc network a specific terminal is responsible for the control and management functions and is designated as central controller. The controller also operates as a normal terminal in the associated subnetwork. The controller is responsible, for example, for the registration of terminals which start operating in the subnetwork, for the connection setup between at least two terminals in the radio transmission medium, for the resource management and for the access control in the radio transmission medium. Thus, for example, a terminal of a subnetwork is allocated transmission capacity for data (packet units) after the registration and after the booking of a transmission request by the controller.

The data can be exchanged between the terminals in the ad hoc network by using a TDMA, FDMA or CDMA method (TDMA=Time Division Multiple Access, FDMA=Frequency Division Multiple Access, CDMA=Code Division Multiple Access). The methods can also be combined. Each subnetwork 1 to 3 of the local area network is assigned a number of specific channels which are designated as channel groups. A channel is determined by a frequency domain, a time domain and, for example, in the case of a CDMA method, by a spreading code. For example, a specific, respectively different frequency domain with a carrier frequency of fi can be available to each subnetwork 1 to 3 for data exchange. Data can be transmitted by means of a TDMA method, for example, in such a frequency domain. In this case, the subnetwork 1 can be allocated the carrier frequency f₁, the subnetwork 2 the carrier frequency f₂, and the subnetwork 3 the carrier frequency f₃. For the bridge terminal 4 to exchange data with the other terminals of the subnetwork 1, it operates with the carrier frequency f₁ and exchange data with the other terminals of the subnetwork 2, it operates with the carrier frequency f₂. The second bridge terminal 5 included in the local area network, which transmits data between the subnetworks 1 and 3, operates with the carrier frequencies f₁ and f₃.

As mentioned above, the central controller has the function of access control, for example. This means that the central controller is responsible for forming frames of the MAC layer (MAC frames). The TDMA method is applied in this case. Such a MAC frame has various channels for control information and useful data.

A block diagram of an example of embodiment of a bridge terminal is illustrated in FIG. 4. The radio switching device of this bridge terminal includes, respectively, a protocol device 24, a modem 25 and a high-frequency circuit 26 with an antenna 27. Connected to the protocol device 24 is a radio switching device 28 which is, moreover, connected to a connection control device 29 and a buffer device 30. In this embodiment, the buffer device 30 includes a memory element and serves to buffer data, and is implemented as a FIFO (First In First Out) module, that is to say, the data are read out of the buffer device 30 in the sequence in which they have been written. The terminal illustrated in FIG. 4 can likewise operate as a normal terminal. Stations connected to the connection control device 29, which are not marked in FIG. 4, then supply data to the radio switching device 28 via the connection control device 29.

The bridge terminal shown in FIG. 4 is synchronized alternately with a first and a second subnetwork. Synchronization is understood to mean the entire process of incorporating a terminal in the subnetwork up to the exchange of data. When the bridge terminal is synchronized with the first subnetwork it can exchange data with all the terminals and with the controller of this first subnetwork. If data whose destination is a terminal or the controller of the first subnetwork or a terminal or controller of another subnetwork which are to be reached via the first subnetwork are supplied by the connection control device 29 to the radio switching device 28, the radio switching device routes these data directly to the protocol device 24. The data are buffered in the protocol device 24 until the time slot for the transmission, which is determined by the controller, is reached. When the data output by the connection control device 29 are to be sent to a terminal or the controller of the second subnetwork or to another subnetwork to be reached via the second subnetwork, the radio transmission must be delayed up to the time interval in which the bridge terminal is synchronized with the second subnetwork. Consequently, the radio switching device routes the data whose destination lies in the second subnetwork or whose destination is to be reached via the second subnetwork to the buffer device 30, which buffers the data until the bridge terminal is synchronized with the second subnetwork.

If data from a terminal or the controller of the first subnetwork are received by the bridge terminal and their destination is a terminal or the controller of the second subnetwork or a terminal or controller of another subnetwork to be reached via the second subnetwork, these data are likewise stored in the buffer device 30 until synchronization with the second subnetwork. Data whose destination is a station of the bridge terminal are passed on directly via the radio switching device 28 to the connection control device 29 which then routes the received data to the desired station. Data whose destination is neither a station of the bridge terminal nor a terminal or a controller of the second subnetwork are sent, for example, to a further bridge terminal.

After the synchronization change of the bridge terminal from the first to the second subnetwork, the data located in the buffer device 30 are read out again from the buffer device 30 in the sequence in which they were written. Subsequently, during the period of the synchronization of the bridge terminal with the second subnetwork, all the data whose destination is a terminal or the controller of the second subnetwork or another subnetwork to be reached via the second subnetwork can be passed on immediately by the radio switching device 28 to the protocol device 24, and only the data whose destination is a terminal or the controller of the first subnetwork or another subnetwork to be reached via the first subnetwork are stored in the buffer device 30.

The MAC frames of two subnetworks SN1 and SN2 are generally not synchronized. Consequently, a bridge terminal BT is not connected to a subnetwork SN1 or SN2 not only during a switchover time Ts but also during a waiting time Tw. This may be gathered from FIG. 5, which shows a sequence of MAC frames of the subnetworks SN1 and SN2 and the MAC frame structure of the bridge terminal BT. The switchover time Ts is the time required for the bridge terminal to be able to synchronize itself with a subnetwork. The waiting time Tw specifies the time between the end of the synchronization with the subnetwork and the beginning of a new MAC frame of this subnetwork.

Assuming that the bridge terminal BT is connected to a subnetwork SN1 or SN2 only for the respective duration of a MAC frame in each case, the bridge terminal BT has only a channel capacity of ¼ of the available channel capacity of a subnetwork. In the other extreme case, in which the bridge terminal BT is connected to a subnetwork for a longer period of time, the channel capacity is half the available channel capacity of a subnetwork.

As described above, as a rule the MAC frames of the various subnetworks are not synchronized with one another. In the case of a connection setup between a bridge terminal and a subnetwork, this results in waiting times (compare FIG. 5: Tw) whose consequence is a delay in the transmission of data between two subnetworks.

According to the invention, synchronizing the MAC frame structure of a plurality of subnetworks connected by a bridge terminal yields a minimization or, if appropriate, also an elimination of the waiting time Tw. Synchronization of the MAC frame structure is then understood to mean that the MAC frames of a plurality of subnetworks which have different carrier frequencies do not begin at the same instant, but rather that the MAC frames are moved relative to one another exactly by the switchover time Ts described in FIG. 5. When the maximum switchover time corresponds exactly to half a MAC frame, this constant move of half a MAC frame duration virtually completely eliminates the waiting times Tw of the two MAC frame structures.

A synchronization method is explained below which is designated as sliding synchronization and in the case of which a constant shift of the MAC frame structure of the subnetworks connected by a bridge terminal is achieved during operation. Three variants of the sliding synchronization can be applied in the case of non-synchronized MAC frame structures.

In the first variant, an unused phase is inserted between two respective MAC frames of the MAC frame structure of a subnetwork SN1, or the MAC frame is lengthened until the overall optimum displacement is achieved. This is synonymous with a delayed transmission of a frame preamble by the controller of the subnetwork SN1. The frame preamble indicates the beginning of a MAC frame and is part of the distribution or broadcast channel BCH which includes, inter alia, control information and which occurs at the start of a MAC frame. This broadcast channel BCH is shown just like the further channels and phases of the MAC frame in FIG. 6. The broadcast channel is followed by a frame channel, which contains information on the allocation of the timeslots during subsequent phases. These phases are a downlink phase (DL phase), a direct link phase (DiL phase) and an uplink phase (UL phase). A random access channel RCH is arranged at the end of the MAC frame. Via this channel, it is possible, for example, for terminals to enter into contact with a controller after switching on. Responses to queries of a terminal via the channel RCH are answered by the controller via a feedback channel ACH (Association feedback channel). The feedback channel ACH follows the frame channel FCH. The phases DL phase, DiL phase and UL phase then follow.

The first variant can be further explained with the aid of FIG. 7 with the aid of two subnetworks SN1 and SN2. Each MAC frame of the subnetwork SN1 is transmitted with a delay, which is synonymous with a lengthened MAC frame. Such a MAC frame then has a duration of Te, where Te>Tn. Tn is the normal duration of a MAC frame and therefore the duration of the MAC frame of the subnetwork SN2. As FIG. 7 further shows, after a few MAC frames the beginning of a MAC frame of the subnetwork temporally corresponds to the end of the switchover time Ts which is required after the end of a MAC frame of the subnetwork SN2 for the synchronization of the bridge terminal with the subnetwork SN1. After the synchronization, the spaces of the successive MAC frames of the subnetwork SN1 again have the duration Tn.

In the second variant, a MAC frame is shortened by a specific time until the desired shift is achieved. A shortening of the frame could be achieved by virtue of the fact that the channel RCH occurring at the end of each MAC frame ends earlier. However, any other channel or any other phase can also be shortened. This second variant can be further explained with the aid of FIG. 8 in which two subnetworks SN1 and SN2 are used. Each MAC frame of the subnetwork SN2 is transmitted in a shortened fashion, which is synonymous with a shortened MAC frame. Such a MAC frame then has a duration of Tk in which case Tk<Tn<Te. Tn is the normal duration of a MAC frame, and thus the duration of the MAC frame of the subnetwork SN1. As FIG. 7 shows further, after a few MAC frames the beginning of a MAC frame of the subnetwork SN1 temporally corresponds to the end of the switchover time Ts which is required after the end of a MAC frame of the subnetwork SN2 for the synchronization of the bridge terminal with the subnetwork SN1. After the synchronization, the MAC frames of the subnetwork SN2 again have the duration Tn.

In the third variant, the first and the second variants are combined with one another. This means that, for example, in the case of two subnetworks, unused phases are inserted or the MAC frames are lengthened in the case of the first subnetwork during the synchronization of successive MAC frames, and the second subnetwork has shortened MAC frames.

In the first and in the second variant, there is a restriction of traffic exclusively in one of the two subnetworks. This restriction admittedly also exists in the case of the third variant, but it is distributed over all the subnetworks involved and not expected unilaterally of one subnetwork.

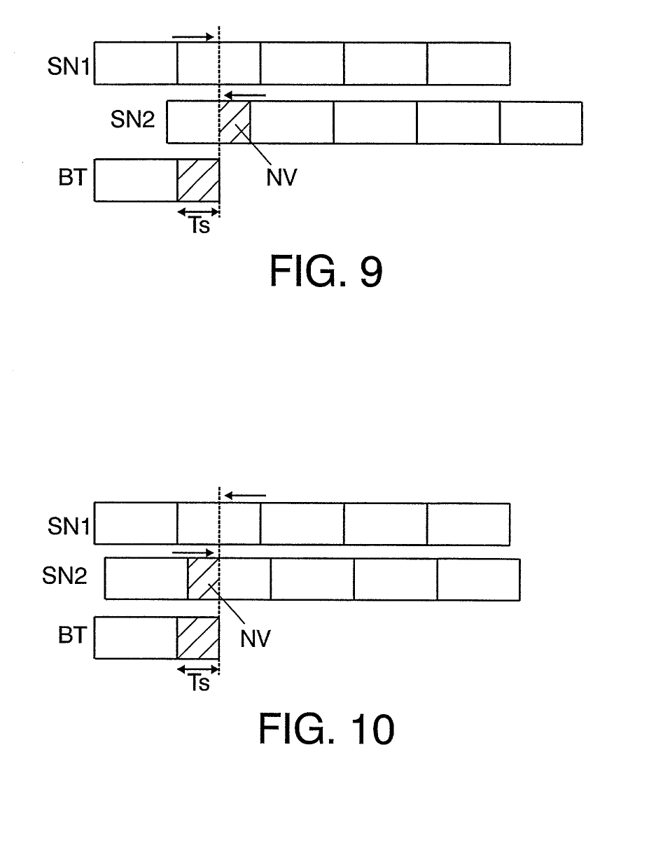

It may be presupposed below that the frame length is 2 ms and the maximum switchover time is Ts=1 ms. It is for these conditions with the aid of FIGS. 9 and 10 that a necessary shift of a MAC frame structure is always smaller than 1 ms. In the first case (FIG. 9), the aim is for a change of the synchronization of the bridge terminal BT to take place from the subnetwork SN1 to the subnetwork SN2. The optimum would be if a MAC frame of the subnetwork SN2 begins directly after the switchover time Ts. The shift of the MAC frame structures relative to one another can be performed in two different directions. The optimum displacement is such that the area NV (NV=required shift) is reduced. Given suitable selection of the direction of the shift, this shift is always less than 1 ms in the example considered. The reverse of the direction of shift is shown in FIG. 10.

The bridge terminal can use the detected frame start times of the integrated subnetworks to decide itself in which direction the frames are to be shifted or moved in each case. The direction and the required magnitude of the shift are communicated to the controllers affected. The controllers then decide themselves the number of frames in which they bring about the overall shift. However, it is also possible for the affected controllers to reach an agreement via the bridge terminal as to the direction in which the frames are to be shifted respectively.

In the case of a shift of 1 ms (extreme case) and in the case of a duration of the sliding synchronization of, for example, 250 MAC frames (5 s), the result is, for example, a delay or shortening of a MAC frame of 4 μs respectively.

1. A network comprising a plurality of subnetworks which can each be connected via bridge terminals and each include a controller for controlling a subnetwork, which controller is provided for shifting the frame structure of its subnetwork to at least a frame structure of another subnetwork.

2. A network as claimed in claim 1, characterized in that a controller is provided for lengthening frames or for inserting an unused phase between successive frames up to a prescribed frame difference relative to the frame structure of the other subnetwork.

3. A network as claimed in claim 1, characterized in that a controller is provided for shortening frames up to a prescribed frame difference relative to the frame structure of the other subnetwork.

4. A network as claimed in claim 1, characterized in that a controller of a first subnetwork is provided for shortening frames, and at least a controller of another subnetwork is provided for lengthening frames or for inserting an unused phase between successive frames up to a prescribed frame difference of the frame structures of the two subnetworks.

5. A network as claimed in claim 1, characterized in that a controller of a subnetwork is provided for communicating with at least another controller of another subnetwork regarding the type of shift.

6. A network as claimed in claim 1, characterized in that a bridge terminal is provided for instructing the controllers of the subnetworks connecting them as to which controller is to carry out a shift and in which direction.

7. A controller in a subnetwork which can be connected to other subnetworks of a network via bridge terminals, the controller being provided
for controlling a subnetwork and
for displacing the frame structure of its network relative to at least one frame structure of another subnetwork.
